(19) United States
(12) Patent Application Publication
(10) Pub. No.: US 2016/0184770 A1
(43) Pub. Date: Jun. 30, 2016

(54) POLYIMIDE MEMBRANE FOR H2S REMOVAL

(71) Applicant: L'Air Liquide, Societe Anonyme pour l'Etude et l'Exploitation des Procedes Georges Claude, Paris (FR)

(72) Inventors: Sudhir S. KULKARNI, Wilmington, DE (US); Dean W. KRATZER, Warwick, MD (US); Edgar S. SANDERS, JR., Newark, DE (US); Gregory K. FLEMING, Paris (FR)

(73) Assignee: L'Air Liquide, Societe Anonyme pour l'Etude et l'Exploitation des Procedes Georges Claude, Paris (FR)

(21) Appl. No.: 14/871,237

(22) Filed: Sep. 30, 2015

Related U.S. Application Data
(60) Provisional application No. 62/098,638, filed on Dec. 31, 2014.

(51) Int. Cl. B01D 53/22; C10L 3/10; B01D 71/64

(52) U.S. Cl. CPC B01D 53/228; B01D 71/64; C10L 3/103; C10L 2290/548

(57) ABSTRACT

H₂S is removed from a feed gas by a gas separation membrane including a separation layer that is made of a blend of P84 and Matrimid.

### CROSS-REFERENCE TO RELATED APPLICATIONS

This application claims the benefit of priority under 35 U.S.C. §119 (e) to U.S. Provisional Patent Application No. 62/098,638, filed Dec. 31, 2014, the entire contents of which are incorporated herein by reference.

### BACKGROUND

1. Field of the Invention

The present invention relates to a method for the separation of H₂S from gases using a gas separation membrane.

2. Related Art

The presence of H₂S in natural gas or industrial process gases is problematic. H₂S is acidic. In many areas, regulations prohibit its flaring or venting when present in relatively high levels. Much work has been done on removing H₂S from natural gas or industrial process gases. However, low cost removal of H₂S from gas mixtures can be a difficult problem. Several have proposed the use of gas separation membranes as a solution to this problem. Others have observed the performance of particular membranes fed with H₂S.

U.S. Pat. No. 4,781,733 discloses a membrane made from polycondensation of a diacid chloride terminated silicone rubber and a diamine. U.S. Pat. No. 4,963,165 discloses a membrane made from polyamide-polyether block copolymer. Each of these reports pure H₂S gas permeability but no data is available for mixed gas separation, much less for mixed gases having much lower concentrations of H₂S. Thus, it is difficult to draw any conclusion on the desirability of this membrane for separation of H₂S from gas mixtures.

Membranes based upon polyether urethane and polyether urethane urea with high H₂S selectivity but low CO₂ selectivity (H₂S/CH₄ ˜70 at 35° C.) are described by Chatterjee (J Membrane Science, 135, 99-106, 1997). However, these membranes exhibit low CO₂ selectivity (CO₂/CH₄˜16 at 35° C.). This can be a major problem for removal of H₂S and CO₂ from natural gas.

Hao, et al (Journal of Membrane Science 209, 177-206, 2002) have studied membrane processes for upgrading natural gas using H₂S-selective, CO₂-selective or both H₂S and CO₂-selective membranes, but these studies are only conceptual in nature.

U.S. Pat. No. 5,401,300 discloses a membrane process for separating CO₂, H₂S, CH₄ and H₂O by relying on the judicious use of two kinds of membranes: a highly H₂S selective membrane (based on a polyamide-polyether block copolymer) and a more CO₂ selective membrane (based on cellulose acetate). This approach of course is more complex than a scheme only using one type of gas separation membrane.

Another combinatory membrane system is disclosed by WO 92/20431. In particular, it describes the use of an H₂S selective membrane (comprising a gel polymer membrane, molten salt membrane and/or rubber copolymer membrane) and an acid gas selective membrane (comprising cellulose acetate, polyimide, polysiloxane and/or pyrolone membrane) in combination with a dehydration membrane (comprising polysiloxane). Again, this kind of approach is more complex than a scheme only using one type of gas separation membrane.

Separation by a facilitated transport membrane is disclosed by U.S. Pat. No. 4,089,653 where H₂S is removed from a mixture of gases including CO₂ by using immobilized liquid membranes of carbonate/bicarbonate solution. US 2008168900A discloses a further refinement of this idea by proposing the use of a membrane based on hydrophilic polymer(s), cross-linking agent(s), base(s), and an amino compound(s). Membranes based on facilitated transport mechanisms can have very attractive selectivity at low acid gas activity, but are as yet not suitable for the high pressures that are typically found in natural gas processing.

The problem of acid gas-induced plasticization of membranes and the associated decreases in membrane performance is well known in the field.

U.S. Pat. No. 4,130,403 discloses a method for removing H₂S and CO₂ from a natural gas using a dried cellulose ester membrane. While such materials have good permeabilities for acid gases, it is known that these materials are susceptible to plasticization and their selectivity (e.g., CO₂/CH₄) decreases strongly with increasing acid gas feed content or partial pressure (Donahue et al, J Membrane Science, 42, 197-214, 1989). This can be a major problem for the removal of both H₂S and CO₂ from a gas mixture such as natural gas.

Bos (Journal of Membrane Science, Volume 155, Issue 1, 31 Mar. 1999, Pages 67-78) and Ismail (Separation and Purification Technology, Volume 27, Issue 3, 1 Jun. 2002, Pages 173-194) describe phenomena resulting in increased permeance and decreased selectivity associated with acid gas plasticization. It is of course desirable to achieve increased permeance and a same or increased selectivity.

Visser, et al (J Membrane Science, 306, 16-28 2007 and J Membrane Science, 252, 265-277, 2005) point out that mass transport in glassy polymeric membranes is determined by both plasticization as well as competitive sorption. In contrast to plasticization, competitive sorption leads to decreased permeability. As the feed mixture pressure increases (higher acid gas activity), the selectivity decreases due to both effects.

Wind, et al (J Membrane Science, 228, 227-236, 2004) teach that CO₂ induced plasticization in polyimides can be decreased by techniques such as thermal annealing or by cross-linking.

Bos, et al (AlChEJ 47(5), 1088-1092, 2001) show that blending of the polyimide Matrimid with copolyimide P84 can stabilize the membrane against plasticization and increase selectivity at the cost of lower permeability. However, no data is given on the effect of H₂S. While increased selectivity is desirable, ideally it should not come at the cost of lower permeability.

Other relevant prior art references include: U.S. Pat. No. 7,018,445; U.S. Pat. No. 7,025,804; and U.S. Pat. No. 5,635,067.

Because H₂S is an acid gas, it is believed that many gas separation membranes, that are fed gas mixtures with relatively high concentrations of H₂S (i.e., above 15 ppm), would exhibit undesirably low permeance and/or selectivity over time due to plasticization, including both for H₂S itself and also for other components in the gas mixture sought to be purified, such as CO₂. Therefore, there is a perception that other gas separation process (such as absorption, cryogenic separation, and adsorption) must be employed in order to remove the H₂S. In the case of natural gas containing significant amounts of H₂S and CO₂, (i.e., 500 ppm or higher) there is a perception that gas separation processes other than membranes must first be used to remove H₂S before CO₂ can be subsequently removed using membranes.

Given the disadvantages of already proposed solutions for separation of H₂S from gas mixtures (such as natural gas, especially natural gas that also contains CO₂), it is an object to provide a process and apparatus for the membrane separation of H₂S.

### SUMMARY OF THE INVENTION

There is disclosed a method of removing H₂S from a feed gas that comprises the following steps. A feed gas comprising at least 2 vol % H₂S is fed to a feed gas inlet of a gas separation membrane apparatus that includes a composite fluid separation membrane, a permeate gas outlet, and a non-permeate gas outlet. A permeate gas comprising H₂S is withdrawn from a permeate outlet of the membrane. A non-permeate gas is withdrawn from a non-permeate outlet of the membrane. The non-permeate gas has a H₂S concentration lower than that of the feed gas. The membrane comprises a separation layer supported by a porous support layer. The porous support layer comprises a polymeric material. The separation layer comprises a blend of a first polymide and a second polymide. The first polymide is represented by formula (I):

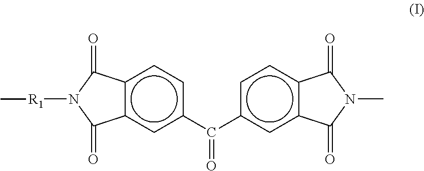

The second polyimide being represented by formula (II):

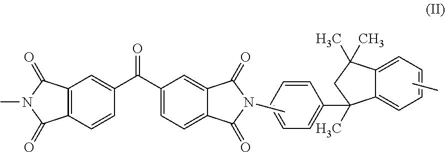

R₁ is a molecular segment selected from the group consisting of the molecular segments of formula (A), formula (B), formula (C), and combinations thereof:

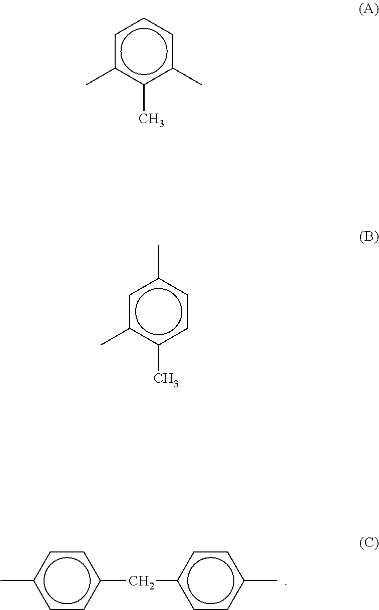

The method may include one or more of the following aspects:
16% of the R₁'s are the molecular segment of formula (A), 64% of the R₁'s are the molecular segment of formula (B), and 20% of the R₁'s are the molecular segment of formula (C).
the feed gas comprises 2-20 vol % of H₂S.
the feed gas is natural gas.
the feed gas is natural gas comprising at least 2 vol % H₂S and a balance of CO₂ and CH₄.
the feed gas is natural gas comprising at least 2 vol % H₂S and a balance of CO₂, CH₄ and N₂.

### BRIEF DESCRIPTION OF THE DRAWINGS

FIG. 1 is a graph of CO₂ permeance and CO₂/N₂ selectivity for gases of various H₂S concentrations.

FIG. 2 is a graph of H₂S permeance and H₂S/CO₂ selectivity for gases of various H₂S concentrations.

FIG. 3 is a graph of CO₂ permeance and CO₂/N₂ selectivity for gases of various H₂S concentrations.

FIG. 4 is a graph of H₂S permeance and H₂S/CO₂ selectivity for gases of various H₂S concentrations.

FIG. 5 is a graph of CO₂ permeance and CO₂/N₂ selectivity for gases of various H₂S concentrations.

FIG. 6 is a graph of H₂S permeance and H₂S/CO₂ selectivity for gases of various H₂S concentrations.

FIG. 7 is a graph of CO₂ permeance and CO₂/N₂ selectivity for gases of various H₂S concentrations.

FIG. 8 is a graph of H₂S permeance and H₂S/CO₂ selectivity for gases of various H₂S concentrations.

### DETAILED DESCRIPTION OF THE INVENTION

The invention is directed towards the use of a membrane having a separation layer made of a particular blend of polyimides that is useful for separating H₂S from gas mixtures. We have found that, at relatively high H₂S concentrations, the membrane exhibits increased H₂S permeance and selectivity.

The polyimide blend includes a first polymide and a second polyimide. The first polymide is present at a concentration of at least 30 wt % and as much as 100 wt %. When present, the second polyimide is at a concentration of less than 70 wt %. Typically, the first polymide is present at a concentration of 30-90 wt % (more typically 60-85) wt % and the second polyimide is present at a concentration of 40-15 wt %. One particular blend includes the first polyimide at a concentration of 70-80 wt % and the second polyimide at a concentration of 30-20 wt %.

The first polymide is represented by formula I.

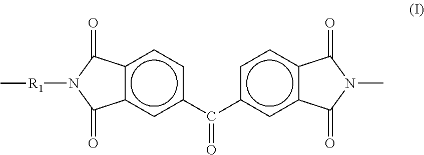

R1 is a molecular segment selected from the group consisting of the molecular segments of formula (A), formula (B), formula (C), and combinations thereof.

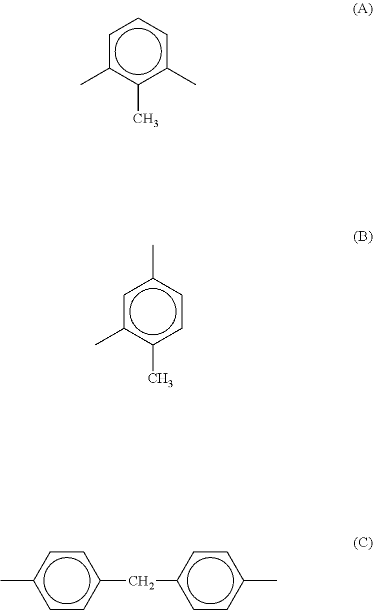

A particularly suitable first polyimide is commercially available from Evonik Fibres GmbH under the trade name P84 in which 16% of the R₁'s are the molecular segment of formula (A), 64% of the R₁'s are the molecular segment of formula (B), and 20% of the R₁'s are the molecular segment of formula (C).

The second polymide is represented by formula (II).

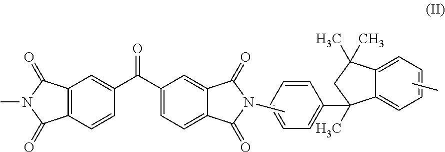

The second polymide is commercially available from Ciba Specialty Chemicals Corp under the trade name of Matrimid. It is the polymeric condensation product of 3,3′,4,4′-benzophenone tetracarboxylic dianhydride and 5(6)-amino-1-(4′-aminophenyl)-1,3,3′-trimethylindane.

The membrane has a composite structure wherein the separation layer extends over a core layer. While composite membrane module may have any configuration known in the field of gas separation, typically it is formed as a spirally wound sheet(s) or as a plurality of hollow fibers. The methods of manufacture for these types of composite membranes are well known to those skilled in the art of membrane separations. The porous support layer provides mechanical strength to the membrane without sacrificing flux. Thus, the porous support layer may be made of any suitable material known in the field of membrane separation to have a flux sufficiently high (for the feed gas at hand) so as to not inhibit permeation of the H₂S through the membrane. In the case of hollow fibers, the porous support layer may have a thickness ranging from about 25 μm to about 300 μm, while the separation layer comprising the blend of P84 and Matrimid is much thinner having a thickness ranging from about 0.1 μm to about 50 μm.

In the case of a spirally wound sheet(s), each sheet may be formed according to techniques well know to the skilled artisan. Typically, the separation layer is coated upon the support layer after the support layer is formed.

In the case of hollow fibers, the fibers may be spun from a spinneret as a composite fluid where the separation layer dope solution is extruded from an outer annulus, the support layer dope solution is extruded from an inner annulus adjacent to the outer annulus, and a bore fluid is injected from a bore on the inside of the inner annulus. The composite fiber may be coagulated and further processed according to well known techniques.

The membrane may be contained within any type of housing known in the art. Their details need not be replicated herein. Generally speaking, the membrane apparatus containing the membrane and housing will include a feed gas inlet into which the feed gas is fed, a permeate gas outlet from which a permeate is withdrawn, and a non-permeate gas outlet (also known as a retentate or residue outlet) from which a non-permeate gas (similarly also known as a retentate or residue gas) is withdrawn.

In operation, the feed gas (comprising H₂S and a balance of one or more gases) is introduced to the feed gas inlet at any desired pressure and temperature. H₂S permeates through the P84 and Matrimid-containing separation layer and an H₂S-containing permeate gas is withdrawn from the permeate gas outlet. A non-permeate gas that is H₂S-deficient compared to the feed gas is withdrawn from the non-permeate outlet. A sweep gas may optionally be fed to the permeate outlet for purposes of enhancing permeation of the H₂S through the membrane by lowering the partial pressure of the H₂S on a side of the membrane opposite that which the feed gas is introduced. In the absence of a sweep gas, the permeate gas has a H₂S concentration higher than that of the feed gas. In the case of a sweep gas, the H₂S concentration in the permeate gas may be higher than, the same as, or lower than that of the feed gas.

The membrane containing the P84/Matrimid separation layer may be used to remove H₂S from a wide variety of feed gases so long as the membrane is less permeable (in comparison to H₂S) to the main component of the balance gas and H₂S is present at a concentration of at least 2 vol %. Typically, the feed gas is natural gas containing at least 2 vol % H₂S and also containing CO₂ and optionally N₂. The concentrations of the CO₂ and N₂ in the feed gas are not critical. Another example of feed gas for which the method of the invention is particularly applicable is shale gas containing at least 2 vol % H₂S. The H2S may be present in the feed gas at a concentration of up to 40 vol %. Therefore, the H2S concentration may range from as low as 2 vol %, 5 vol %, or 10 vol % and as high as 40 vol %, 30 vol %, 20 vol %, 10 vol %, or 5 vol %.

### EXAMPLES

### Example 1

Composite hollow fiber membranes were spun using a core/substrate composed of P84 polyimide and a separating skin layer of a blend of P84 and Matrimid. One group (L) of the spun membranes was washed, dehydrated by solvent exchange and post-treated as described in U.S. Pat. No. 5,091,216. Another group (F) of the spun membranes was washed, dehydrated by solvent exchange and post-treated as described in U.S. Pat. No. 5,091,216. The only difference between the F and L membranes is the concentration of the post-treatment chemicals—the concentration of post-treatment chemicals for F is five times that of L. The hollow fibers were then potted in mini-permeators and tested with various gas mixtures.

Some mini permeators including the F-type membranes were tested with CO₂/N₂ mixtures containing different levels of H₂S:

1A: 10 vol % CO₂ and 90 vol % N₂

1B: 500 ppm H₂S and 10 vol % CO₂ with a balance of N₂

1C: 5 vol % H₂S, 5 vol % CO₂, and 90 vol % N₂

1D: 19 vol % H₂S, 21 vol % CO₂, and 60 vol % N₂

1E: 19 vol % H₂S, 21 vol % CO₂, and 60 vol % N₂ (after 13 days)

1F: 10 vol % CO₂ and 90 vol % N₂

Measurements were taken at a feed pressure of ˜200 psig and a temperature of 50° C. The feed, permeate and non-permeate compositions were measured as were the permeate and non-permeate flow rates. Permeances were calculated from the performance assuming ideal counter-current behavior in the minipermeators. The results are shown in Table 1 below:

TABLE 1
Membrane performance for CO₂/N₂ containing various levels of H₂S

| | | Feed composition | | | | | |
|---|---|---|---|---|---|---|---|
| | | 1A | 1B | 1C | 1D | 1E | 1F |
| Test day | | 1 | 2 | 21 | 27 | 40 | 45 |
| Feed | T (° C.) | 50 | 50 | 50 | 50 | 50 | 50 |
| | P (psig) | 205 | 205 | 205 | 205 | 200 | 200 |
| Permeance | CO₂ | 35.9 | 38.0 | 54.1 | 84.1 | 114.9 | 47.7 |
| | (GPU) | | | | | | |
| | H₂S | — | 16.3 | 33.1 | 58.3 | 83.9 | — |
| | (GPU) | | | | | | |
| | N₂ (GPU) | 1.8 | 1.8 | 1.99 | 2.1 | 2.7 | 2.1 |
| Selectivity | CO₂/N₂ | 20.5 | 21.0 | 27.2 | 39.6 | 41.9 | 22.7 |
| | H₂S/N₂ | — | 9.0 | 16.7 | 27.5 | 30.6 | — |
| | CO₂/H₂S | — | 2.3 | 1.6 | 1.4 | 1.4 | — |

As seen in Table I, CO₂ permeance and selectivity vs. N₂ are similar in either binary mixtures or ternary mixtures including low (˜500 ppm) levels of H₂S. With no or low levels of H₂S, the H₂S permeance is significantly less than that of CO₂. In contrast, at higher levels (5 vol % H₂S), H₂S permeance doubles in comparison to lower levels (500 ppm H₂S). Surprisingly, H₂S selectivity vs. N₂ also increases. This shows that this is not the well-known plasticization phenomena where increased permeance is associated with decreased selectivity. This beneficial and surprising tendency of improved H₂S permeance and H₂S/N₂ selectivity at relatively higher levels (5 vol % H₂S) becomes even stronger at much higher levels (19 vol % H₂S) levels. The benefit of the improved acid gas permeance and selectivity at high H₂S levels is also seen for CO₂ permeance and CO₂/N₂ selectivity. Moreover, the good performance of the membrane does not deteriorate over time. After 13 days of 19 vol % H₂S, permeance of H2S and CO2 improves without any decrease in H₂S/N₂ or H₂S/CO₂ selectivity. Finally, re-testing the membrane with binary CO₂/N₂ containing no H₂S also indicates membrane stability after exposure to quite high levels of H₂S.

### Example 2

An F-type mini permeator from Example 1 was tested with CO₂/CH₄ mixtures containing H₂S at either 512 ppm or at 20 vol %:

2A: 512 ppm H₂S with a balance of 1:4 (vol:vol) mixture of CO₂:CH₄

2B: 512 ppm H₂S with a balance of 1:4 (vol:vol) mixture of CO₂:CH₄

2C: 20 vol % H₂S, 20 vol % CO₂, and 60 vol % CH₄

Measurements were taken at a temperature of 37° C. The feed pressure was either 200 or 800 psig for the mixture containing 512 ppm H2S. The feed pressure was measured at an intermediate 400 psi for the mixture containing 20% H2S. The membrane permeance and selectivity was calculated in the same manner as Example 1. The results are shown in Table 2 below.

TABLE 2
Membrane performance for CO₂/CH₄ containing various levels of H₂S

| | | Feed composition | | |
|---|---|---|---|---|
| | | 2A | 2B | 2C |
| Feed | T (° C.) | 37 | 37 | 37 |
| | P (psig) | 200 | 800 | 400 |
| Permeance | CO₂ (GPU) | 19.1 | 12.2 | 42.4 |
| | H₂S (GPU) | 11.4 | 8.2 | 44.8 |
| | CH₄ (GPU) | 50.7 | 36.1 | 31.1 |
| Selectivity | CO₂/CH₄ | 50.7 | 36.1 | 31.1 |
| | H₂S/CH₄ | 30.4 | 24.4 | 32.9 |
| | CO₂/H₂S | 1.7 | 1.5 | 0.9 |

As seen in Table 2, higher feed pressure leads to lower values of CO₂ and H₂S permeance and selectivity at the low H₂S concentrations. However, when comparing the performance at 20 vol % H₂S vs. 512 ppm H₂S, even at higher pressure (400 psi vs. 200 psi), the H₂S permeance increases by just under 300% with a slightly higher H₂S/CH₄ selectivity when the H₂S concentration is at 20 vol %.

### Example 3

An L-type mini permeator from Example 1 was tested with CO₂/CH₄ mixtures containing H₂S at either 512 ppm or 20 vol % using the same protocol as in Example 2:

3A: 512 ppm H₂S with a balance of a 1:4 (vol:vol) mix of CO₂ and CH₄

3B: 512 ppm H₂S with a balance of a 1:4 (vol:vol) mix of CO₂ and CH₄

3C: 20 vol % H₂S, 20 vol % CO₂, and 60 vol % CH₄

The results are shown in Table 3 below:

TABLE 3
Membrane performance for CO₂/CH₄ containing various levels of H₂S

| | | Feed composition | | |
|---|---|---|---|---|
| | | 3A | 3B | 3C |
| Feed | T (° C.) | 37 | 37 | 37 |
| | P (psig) | 200 | 800 | 400 |
| Permeance | CO₂ (GPU) | 40.70 | 23.24 | 79.83 |
| | H₂S (GPU) | 21.38 | 10.75 | 95.84 |
| | CH₄ (GPU) | 47.70 | 40.74 | 24.89 |
| Selectivity | CO₂/CH₄ | 47.70 | 40.74 | 24.89 |
| | H₂S/CH₄ | 25.06 | 18.84 | 29.57 |
| | CO₂/H₂S | 1.9 | 2.2 | 0.8 |

As shown in Table 3, the above-described advantages are even stronger for the L-type membranes than with the F-type membranes of Example 2. When comparing the performance for 20 vol % H₂S versus 512 ppm H₂S, even at higher pressure (400 psi vs. 200 psi), the H₂S permeance is increased by almost 350%.

### Comparative Example 1

A composite hollow fiber membrane was spun using a core/substrate composed of Ultem polyimide and a separating composite skin layer of Matrimid polyimide. The spun membrane fiber was washed, solvent exchanged and post-treated in the same manner as in Example 1.

Minipermeators were made and tested by the same methodology as in Example 1. The feed compositions are as follows:

CE1-1: 40 vol % CO₂ and 60 vol % N₂

CE1-2: 10 vol % CO₂ and 90 vol % N₂

CE1-3: 20 vol % H₂S, 20 vol % CO₂, and 60 vol % N₂

CE1-4: 20 vol % H₂S, 20 vol % CO₂, and 60 vol % N₂ (after 33 days)

CE1-5: 40 vol % CO₂ and 60 vol % N₂

The results are shown in Table 4.

TABLE 4
Membrane performance for CO₂/N₂ containing various levels of H₂S

| | | Feed composition | | | | |
|---|---|---|---|---|---|---|
| | | CE1-1 | CE1-2 | CE1-3 | CE1-4 | CE1-5 |
| Test day | | 1 | 2 | 4 | 35 | 42 |
| Feed | T (° C.) | 50 | 50 | 50 | 50 | 50 |
| | P (psig) | 200 | 200 | 200 | 200 | 200 |
| Permeance | CO₂ | 46.2 | 53.3 | 56.1 | 38.7 | 20.8 |
| | (GPU) | | | | | |
| | H₂S | — | — | 56.4 | 33.2 | — |
| | (GPU) | | | | | |
| | N₂ (GPU) | 2.5 | 2.07 | 2.18 | 1.22 | 1.2 |
| Selectivity | CO₂/N₂ | 18.4 | 25.8 | 25.8 | 31.6 | 17.4 |
| | H₂S/N₂ | — | — | 25.9 | 27.1 | — |
| | CO₂/H₂S | — | — | 0.99 | 1.17 | — |

As seen in Table 4, the membrane performance at 20 vol % H₂S is initially good. However, the performance clearly deteriorates over 33 days testing at this condition. CO₂ permeance drops by 31% and H₂S permeance drops by 41%. Re-testing the membrane with binary CO₂/N₂ also confirms membrane permeance loss after exposure to high H₂S levels.

### Comparative Example 2

A monolithic fiber (not composite) made of only P84 was spun. The spun fiber was washed, solvent exchanged and post-treated as for the F-type fibers in Example 1.

Minipermeators were made and tested by the same methodology as in Example 1. The feed compositions were as follows:

CE2-1: 10 vol % CO₂ and 90 vol % N₂

CE2-2: 5 vol % H₂S, 5 vol % CO₂, and 90 vol % N₂

CE2-3: 20 vol % H₂S, 20 vol % CO₂, and 60 vol % N₂

CE2-4: 20 vol % H₂S, 20 vol % CO₂, and 60 vol % N₂ (after 2 days)

The results are shown in Table 5.

TABLE 5
Membrane performance for CO₂/N₂ containing various levels of H₂S

| | | Feed composition | | | |
|---|---|---|---|---|---|
| | | CE2-1 | CE2-2 | CE2-3 | CE2-4 |
| Test day | | 1 | 3 | 5 | 7 |
| Feed | T (° C.) | 50 | 50 | 50 | 50 |
| | P (psig) | 205 | 205 | 200 | 490 |
| Permeance | CO₂ | 37.4 | 31.7 | 79.9 | 44.7 |
| | (GPU) | | | | |
| | H₂S | — | 22.5 | 64.5 | 40.3 |
| | (GPU) | | | | |
| | N₂ (GPU) | 1.6 | 1.2 | 1.77 | 1.4 |
| Selectivity | CO₂/N₂ | 23.6 | 27.2 | 45.0 | 32.6 |
| | H₂S/N₂ | — | 19.3 | 36.3 | 29.4 |
| | CO₂/H₂S | — | 1.4 | 1.2 | 1.1 |

As seen in Table 5, the P84-only fiber shows a similar performance improvement as for the P84/Matrimid composite blend of Example 1. However, the improvement is less and the performance stability is poor. After only 2 days, all of the performance indicators decreased for 20 vol % H₂S. Without being bound by any particular theory, we believe that, in the absence of the Matrimid, the chains of the P84 polymer are caused to align after exposure to high concentrations of H₂S—thereby decreasing permeance. On the other hand, we believe that the presence of Matrimid in the P84/Matrimid blend prevents the P84 polymer chains from similarly aligning. As seen above in Example 1-3, the P84/Matrimid blend does not exhibit performance instability.

### Comparative Example 3

Monolithic fibers were with polysulfone alone and then solvent washed and coated with a blend of cellulose acetate and polymethyl methacrylate as taught by the prior art. Minipermeators were made and tested by the same methodology as Example 1. The feed compositions are as follows:

CE3-1: 10 vol % CO₂ and 90 vol % N₂

CE3-2: 5 vol % H₂S, 5 vol % CO₂, and 90 vol % N₂

CE3-3: 20 vol % H₂S, 20 vol % CO₂, and 60 vol % N₂

CE3-4: 20 vol % H₂S, 20 vol % CO₂, and 60 vol % N₂ (after 11 days)

CE3-5: 10 vol % CO₂ and 90 vol % N₂

The results are shown in Table 6.

TABLE 6
Membrane performance for CO₂/N₂ containing various levels of H₂S

| | | Feed composition | | | | |
|---|---|---|---|---|---|---|
| | | CE3-1 | CE3-2 | CE3-3 | CE3-4 | CE3-5 |
| Test day | | 1 | 3 | 6 | 17 | 18 |
| Feed | T (° C.) | 50 | 50 | 50 | 50 | 50 |
| | P (psig) | 200 | 200 | 210 | 204 | 210 |
| Permeance | CO₂ | 49.9 | 42.0 | 56.6 | 52.6 | 47.4 |
| | (GPU) | | | | | |
| | H₂S | — | 36.2 | 39.1 | 38.6 | — |
| | (GPU) | | | | | |
| | N₂ (GPU) | 2.3 | 2.1 | 2.03 | 2.3 | 2.5 |
| Selectivity | CO₂/N₂ | 22.0 | 19.7 | 27.9 | 23.1 | 19.0 |
| | H₂S/N₂ | — | 17.0 | 19.3 | 17.0 | — |
| | CO₂/H₂S | — | 1.2 | 1.4 | 1.4 | — |

As seen in Table 6, this membrane shows stable performance but does not exhibit any improvement in performance when exposed to high H₂S levels.

### Example 4

Some mini permeators including the F-type membranes were tested with CO₂/N₂ mixtures or CO₂/CH₄ mixtures containing different levels of H₂S:

4A: 20 vol % CO₂ and 80 vol % N₂

4B: 512 ppm H₂S with a balance of 20 vol % CO₂ and 80 vol % CH₄

4C: 500 vol % H₂S with a balance of 30 vol % CO₂ and 70 vol % CH₄

4D: 2 vol % H₂S, 20 vol % CO₂ and 78 vol % CH₄

4E: 5 vol % H₂S, 5 vol % CO₂ and 90 vol % N₂

4F: 21 vol % H₂S, 19 vol % CO₂ and 60 vol % N₂

Measurements were taken at varying feed pressures and temperatures. The feed, permeate and non-permeate compositions were measured as were the permeate and non-permeate flow rates. Permeances were calculated from the performance assuming ideal counter-current behavior in the minipermeators. The results are shown in Tables 7-10 below:

TABLE 7
Membrane performance for feed gas containing various levels of H₂S

| | | Feed composition | | | |
|---|---|---|---|---|---|
| | | 4A | 4D | 4E | 4F |
| Feed | T (° C.) | 20 | 23 | 22 | 21 |
| | P (psig) | 200 | 200 | 205 | 200 |
| Permeance | CO₂ | 20.18 | 23.84 | 24.3 | 65.6 |
| | (GPU) | | | | |
| | H₂S | — | 12.26 | 13.9 | 55.6 |
| | (GPU) | | | | |
| Selectivity | H₂S/CO₂ | — | 0.51 | 0.57 | 0.85 |
| | CO₂/N₂ | 30 | — | 43.8 | 84.8 |

TABLE 8
Membrane performance for feed gas containing various levels of H₂S

| | | Feed composition | | | |
|---|---|---|---|---|---|
| | | 4A | 4D | 4E | 4F |
| Feed | T (° C.) | 20 | 23 | 22 | 21 |
| | P (psig) | 500 | 500 | 490 | 490 |
| Permeance | CO₂ | 16.07 | 20.13 | 12.7 | 63.6 |
| | (GPU) | | | | |
| | H₂S | — | 10.35 | 8.4 | 58.9 |
| | (GPU) | | | | |
| Selectivity | H₂S/CO₂ | — | 0.51 | 0.66 | 0.93 |
| | CO₂/N₂ | 28 | — | 38.6 | 67.1 |

TABLE 9
Membrane performance for feed gas containing various levels of H₂S

| | | Feed composition | | | |
|---|---|---|---|---|---|
| | | 4A | 4B | 4E | 4F |
| Feed | T (° C.) | 37 | 35 | 37 | 37 |
| | P (psig) | 200 | 200 | 200 | 200 |
| Permeance | CO₂ | 25.8 | 19.07 | 34.4 | 99.1 |
| | (GPU) | | | | |
| | H₂S | — | 11.42 | 19.9 | 78.9 |
| | (GPU) | | | | |
| Selectivity | H₂S/CO₂ | — | 0.60 | 0.58 | 0.80 |
| | CO₂/N₂ | 19 | — | 22.8 | 34.1 |

TABLE 10
Membrane performance for feed gas with various levels of H₂S

| | | Feed composition | | | |
|---|---|---|---|---|---|
| | | 4A | 4C | 4E | 4F |
| Feed | T (° C.) | 50 | 50 | 50 | 50 |
| | P (psig) | 500 | 600 | 500 | 500 |
| Permeance | CO₂ | 25.19 | 29.85 | 28.6 | 108.0 |
| | (GPU) | | | | |
| | H₂S | — | 12.8 | 20.1 | 87.4 |
| | (GPU) | | | | |
| Selectivity | H₂S/CO₂ | — | 0.43 | 0.70 | 0.81 |
| | CO₂/N₂ | 19 | — | 22.8 | 34.1 |

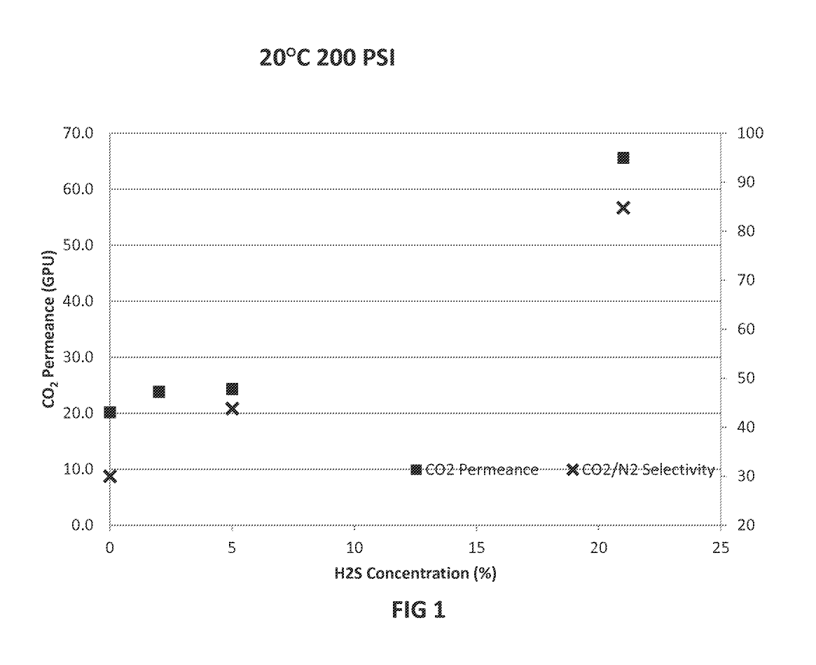

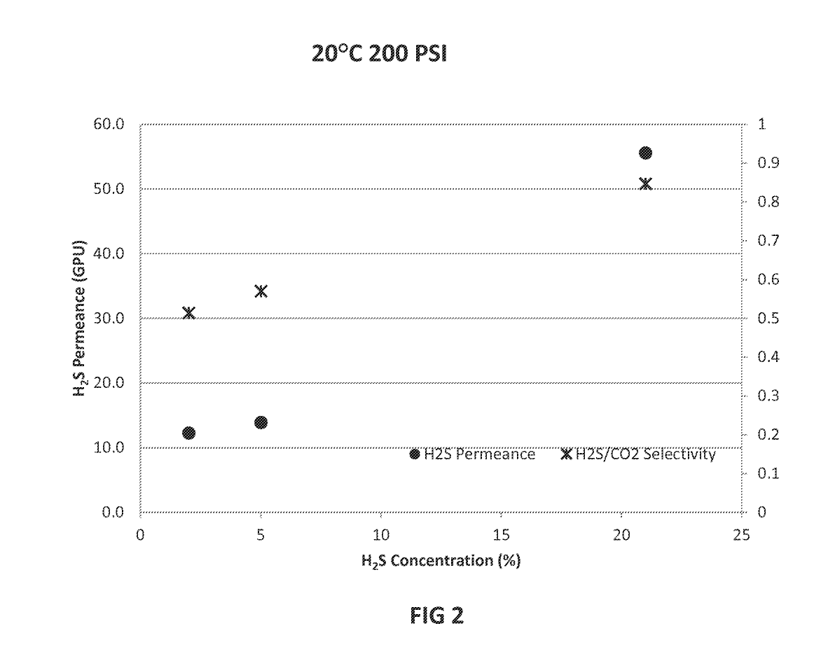

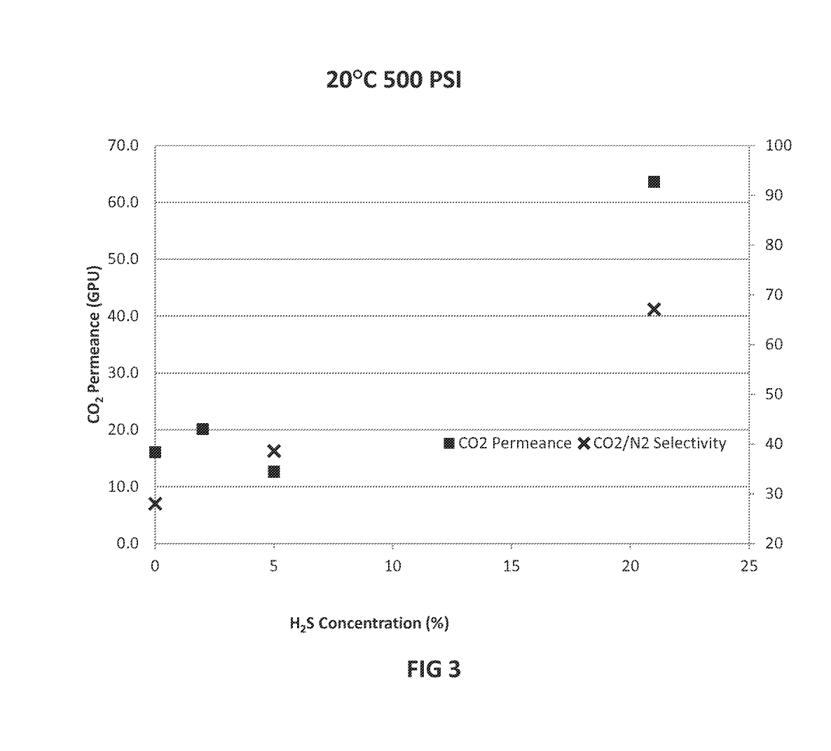

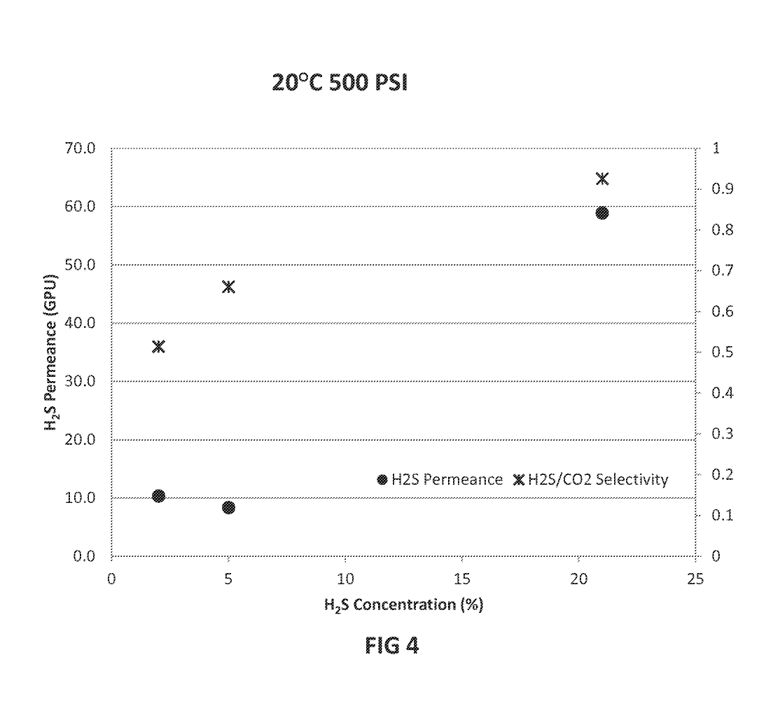

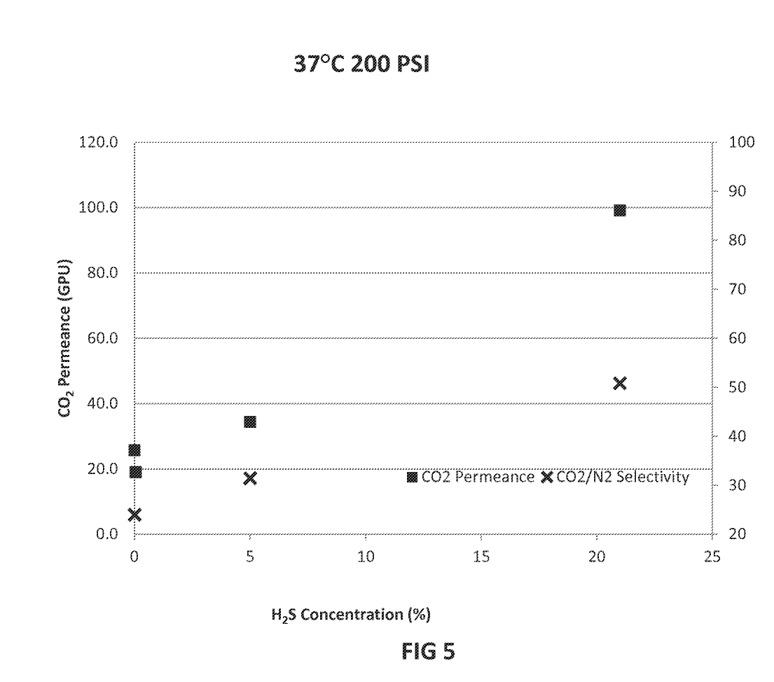

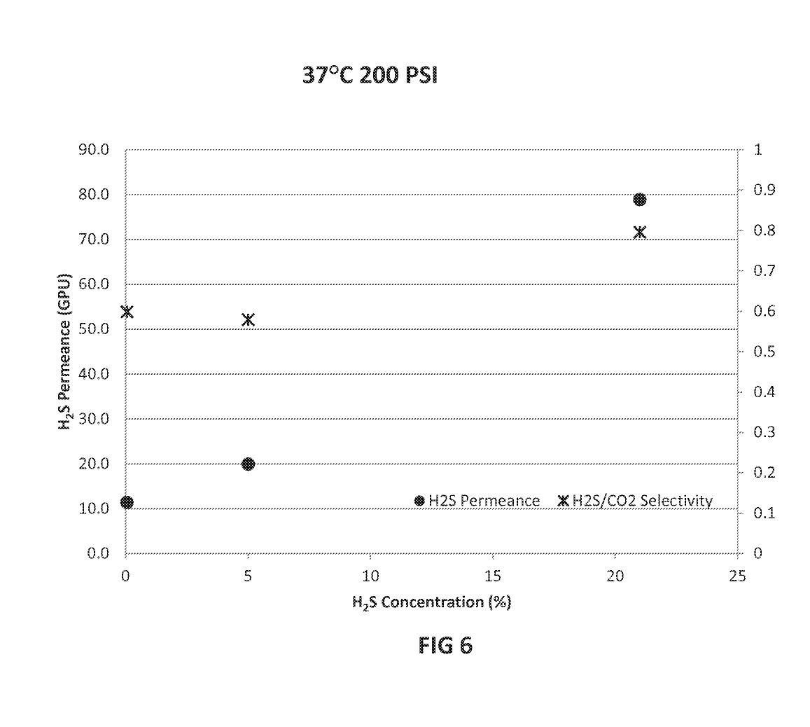

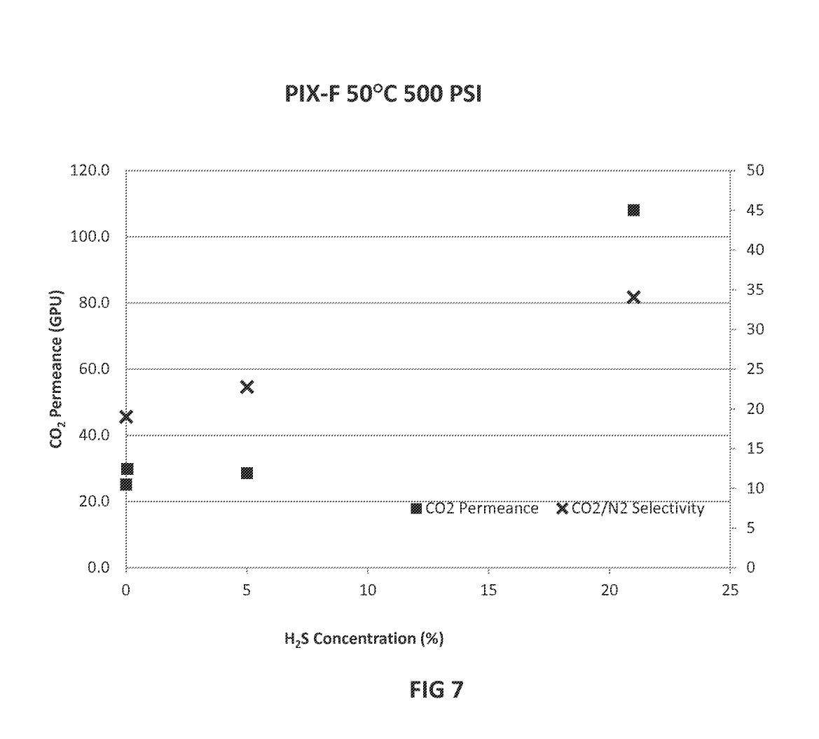

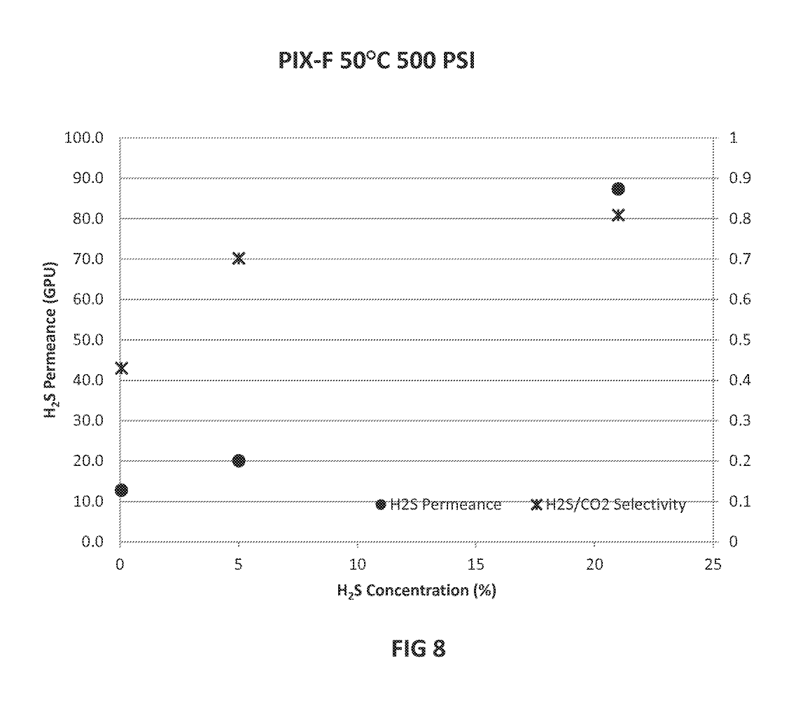

As seen in FIGS. 1-8, membrane separation of H2S-containing feed gases is particularly advantageous when using a separation layer comprising P84 and Matrimid.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not Occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A method of removing H₂S from a feed gas, comprising the steps of:
feeding the feed gas comprising at least 2 vol % H₂S to a feed gas inlet of a gas separation membrane apparatus that includes a composite fluid separation membrane, a permeate gas outlet, and a non-permeate gas outlet, the membrane comprising a separation layer supported by a porous support layer, the porous support layer comprising a polymeric material, the separation layer comprising a first polymide optionally blended with a second polymide, the first polymide being represented by formula (I): 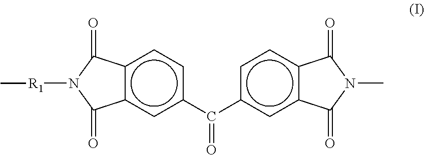
the second polyimide being represented by formula (II): 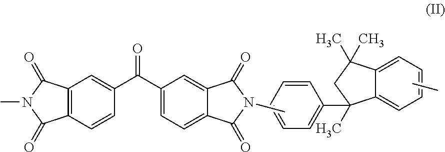
where R₁ is a molecular segment selected from the group consisting of the molecular segments of formula (A), formula (B), formula (C), and combinations thereof: 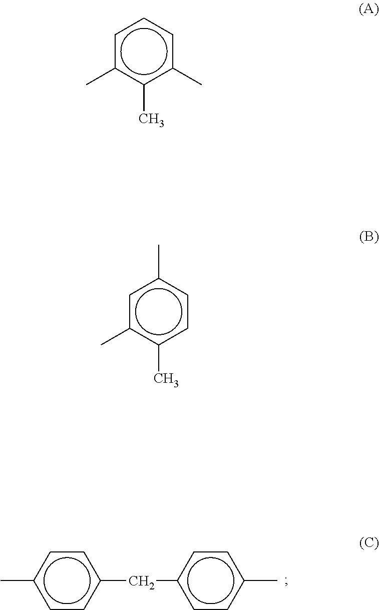
withdrawing a permeate gas comprising H₂S from a permeate outlet of the membrane; and
withdrawing a non-permeate gas from a non-permeate outlet of the membrane, wherein the non-permeate gas has a H₂S concentration lower than that of the feed gas.

2. The method of claim 1, wherein 16% of the R₁'s are the molecular segment of formula (A), 64% of the R₁'s are the molecular segment of formula (B), and 20% of the R₁'s are the molecular segment of formula (C).

3. The method of claim 1, wherein the feed gas comprises 2 vol % to 20 vol % of H₂S.

4. The method of claim 1, wherein the feed gas comprises 5-20 vol % of H₂S.

5. The method of claim 1, wherein the feed gas is natural gas.

6. The method of claim 1, wherein the feed gas is natural gas comprising at least 500 ppm H₂S and a balance of CO₂ and CH₄.

7. The method of claim 1, wherein the feed gas is natural gas comprising at least 500 ppm H₂S and a balance of CO₂, CH₄ and N₂.

8. The method of claim 1, wherein:
16% of the R₁'s are the molecular segment of formula (A), 64% of the R₁'s are the molecular segment of formula (B), and 20% of the R₁'s are the molecular segment of formula (C); and
the feed gas comprises 500 ppm to 20 vol % of H₂S.

9. The method of claim 8, wherein the feed gas is natural gas.

10. The method of claim 8, wherein the feed gas is natural gas comprising at least 500 ppm H₂S and a balance of CO₂ and CH₄.

11. The method of claim 8, wherein the feed gas is natural gas comprising at least 500 ppm H₂S and a balance of CO₂, CH₄ and N₂.

12. The method of claim 1, wherein:
16% of the R₁'s are the molecular segment of formula (A), 64% of the R₁'s are the molecular segment of formula (B), and 20% of the R₁'s are the molecular segment of formula (C); and
the feed gas is natural gas.

13. The method of claim 1, wherein:
16% of the R₁'s are the molecular segment of formula (A), 64% of the R₁'s are the molecular segment of formula (B), and 20% of the R₁'s are the molecular segment of formula (C); and
the feed gas is natural gas comprising at least 500 ppm H₂S and a balance of CO₂ and CH₄.

14. The method of claim 1, wherein:
16% of the R₁'s are the molecular segment of formula (A), 64% of the R₁'s are the molecular segment of formula (B), and 20% of the R₁'s are the molecular segment of formula (C); and
the feed gas is natural gas comprising at least 500 ppm H₂S and a balance of CO₂, CH₄ and N₂.

15. The method of claim 1, wherein the feed gas is natural gas comprising 500 ppm of H₂S.

16. The method of claim 15, wherein the feed gas is natural gas comprising at least 500 ppm H₂S and a balance of CO₂ and CH₄.

17. The method of claim 15, wherein the feed gas is natural gas comprising at least 500 ppm H₂S and a balance of CO₂, CH₄ and N₂.

18. The method of claim 1, wherein the separation layer comprises the first polyimide but not the second polyimide.

19. The method of claim 1, wherein the separation layer comprises a blend of the first and second polyimides.
